(19) United States
(12) Patent Application Publication
(10) Pub. No.: US 2013/0242920 A1
(43) Pub. Date: Sep. 19, 2013

(54) METHOD AND APPARATUS FOR ENHANCING DOWNLINK HARQ

(71) Applicants: Gang Wang, Beijing (CN); Ming Lei, Beijing (CN)

(72) Inventors: Gang Wang, Beijing (CN); Ming Lei, Beijing (CN)

(73) Assignee: NEC (CHINA) CO., LTD., Beijing (CN)

(21) Appl. No.: 13/879,299

(22) PCT Filed: Aug. 1, 2011
(86) PCT No.: PCT/CN2011/077846

§ 371 Date: Jun. 3, 2013

(51) Int. Cl. H04W 72/08

(52) U.S. Cl. CPC H04W 72/085
USPC 370/329

(57) ABSTRACT

Embodiments of the invention provide a method for enhancing downlink HARQ. The method may comprise steps of: responsive to that a packet is unsuccessfully received, estimating a required channel quality for next retransmission of the packet; selecting a target subset of base stations from a cooperation set of base stations based on the required channel quality; and sending an indication of the target subset of base stations to a central unit.

### FIELD OF THE INVENTION

Embodiments of the present invention generally relate to communication techniques. More particularly, embodiments of the present invention relate to a method and apparatus for enhancing downlink Hybrid automatic repeat request (HARQ).

### BACKGROUND OF THE INVENTION

3GPP LTE and LTE-Advanced, also known as the evolution standard of the great success of GSM/HSPA technology, is aiming at creating a new series of specifications for the new evolving radio-access technology. One of its goals is to go on improving the cellular communication system performance, such as the higher throughput and achieving low packet transmission latency. In LTE release 8-10, the cell-edge UE's throughput performance is susceptible to the problem of the weak signal strength and the severe inter-cell interference from the neighboring cells. For this type of UE, on the one hand, its receiving signal strength is attenuated by the path loss since it usually locates far from its serving base station (e.g., eNB) site. On the other hand, it experiences high interference from the neighboring cells because of the LTE's single frequency network (SFN) nature, in which all the cells in the system use the same frequency bands for the downlink data transmission.

To solve such a problem, two kinds of improvement methods have been proposed to the 3GPP standardization group. One way is to increase the receiving signal strength of the cell-edge UE by introducing small cells, also known as heterogeneous network (HetNet), such as femto-cell, pico-cell or relay. The other way is to decrease the inter-cell interference by interference coordination. It includes enhanced inter-cell interference coordination (eICIC), which has been standardized in 3GPP release 10; and coordinated multi-point (CoMP), which will be standardized by 3GPP release 11.

The core idea of CoMP is, for a cell-edge UE in the downlink data transmission, it usually receives data signals from multiple eNBs at the same time, including its serving eNB and its neighboring cell eNB. Generally, the signal received from the neighboring cell is regarded as the inter-cell interference and leads to negative effect in the UE's ability to decode the data information successfully. With CoMP, the signal transmitted from the multiple cells would be coordinated to mitigate the original interference.

The typical CoMP network structure includes a central unit (CU) which connects all eNBs in the system via fiber or cable. Each eNB, also known as coordinated eNB, serves some UEs in each cell. For the cell-edge UE, it could receive data signal from multiple eNBs from its wireless interface. Those eNBs could form the cooperation set. And the UE which could receive data information from the eNBs in the cooperation set is referred as CoMP UE (also called “UE” for purpose of briefly in below).

In such a network, CU coordinates the eNBs in the cooperation set to send data packet to the CoMP UE. It first sends the multi-cell scheduling result together with the data packet to the eNBs in the cooperation set. eNBs in the cooperation set are responsible to send the data information to the CoMP UE in a joint manner. At the UE side, the data information from multiple eNBs are combined together to improve the receiving signal quality, so that the data information can be received by the CoMP UE with high reliability.

In LTE system, to improve the packet receiving reliability, HARQ is always used in the system. It plays an important role in maximizing the spectral efficiency when the packet transmission error occurs. The idea of HARQ is as below. When a packet is received by the UE successfully, the UE will send an ACK packet to the central unit; otherwise, the UE would send an NACK packet to the central unit indicating the central unit to retransmit the unsuccessfully received packet.

Conventional CoMP UE generally comprises a HARQ combiner, a channel decoder, a CRC detector and a feedback transmitter. In a conventional communication block of HARQ process in a CoMP UE, demodulated data bits are sent to HARQ combiner. The HARQ combiner combines multiple retransmission bits which have different redundancy version (RV) of the same packet for channel decoding. The RV specifies the starting point of the retransmission bits in the original transmitted packet, so that the HARQ combiner could combine them with the previous transmitted packet together. The combining method is an implementation issue and the manufactures usually use chase combining (CC) or incremental redundancy (IR) methods. The channel decoder decodes the combined data bits and sends the decoded bits to CRC detector. CRC detector calculates the CRC value of the decoded packet and compares it with the CRC information carried in the original data packet. So it could decide whether the packet is received successfully or not. And it sends the decision to the feedback transmitter. Feedback transmitter sends an ACK packet to the scheduler in the central unit if the packet is received successfully, or an NACK. If an NACK is received by the central unit, and the number of retransmission attempts has not reached the maximum retransmission limit, the corresponding packet will be retransmitted to the UE and the number of retransmission attempt is increased by one.

In the traditional CoMP HARQ operation, the same number of eNBs in the CoMP cooperation set will send the retransmission packet to the CoMP UE. However, there are cases when only part of the eNBs in the CoMP cooperation set is enough for the packet retransmission to recover the packet information in the CoMP UE, and in this case, use of all the eNBs in the cooperation set is a waste of precious radio resource.

### SUMMARY OF THE INVENTION

In view of the foregoing problems, there is a need in the art to provide methods and apparatuses for enhancing downlink HARQ by using a subset of base stations in the cooperation set, which are enough for recovering the packet information from retransmitted data, to perform the next retransmission of the packet.

According to a first aspect of the present invention, embodiments of the invention provide a method for enhancing downlink HARQ. The method may comprise: responsive to that a packet is unsuccessfully received, estimating a required channel quality for next retransmission of the packet; selecting a target subset of base stations from a cooperation set of base stations based on the required channel quality; and sending an indication of the target subset of base stations to a central unit.

According to a second aspect of the present invention, embodiments of the invention provide a method for enhancing downlink HARQ. The method may comprise steps of: receiving an indication of the target subset of base stations for next retransmission; and notifying the base stations in the target subset to retransmit the packet.

According to a third aspect of the present invention, embodiments of the invention provide an apparatus for enhancing downlink HARQ. The apparatus may comprise: an estimating device, configured to responsive to that a packet is unsuccessfully received, estimate a required channel quality for next retransmission of the packet; a selecting device, configured to select a target subset of base stations from a cooperation set of base stations based on the required channel quality; and a sending device, configured to send an indication of the target subset of base stations to a central unit. The apparatus may be used in a UE.

According to a fourth aspect of the present invention, embodiments of the invention provide an apparatus for enhancing downlink HARQ. The apparatus may comprise: a receiving device, configured to receive an indication of the target subset of base stations for next retransmission; and a notifying device, configured to notify the base stations in the target subset to retransmit the packet. The apparatus may be used in a central unit.

The following benefits can be expected with the invention. Some eNBs can be saved to transmit other data information if retransmission of the packet does not need all the eNBs in the cooperation set, thus the throughput performance of the CoMP system is improved.

Other features and advantages of the embodiments of the present invention will also be apparent from the following description of specific embodiments when read in conjunction with the accompanying drawings, which illustrate, by way of example, the principles of embodiments of the invention.

### BRIEF DESCRIPTION OF THE DRAWINGS

Embodiments of the invention are presented in the sense of examples and their advantages are explained in greater detail below, with reference to the accompanying drawings, where

FIG. 1 illustrates a flow chart of a method for enhancing downlink HARQ according to an embodiment of the invention;

FIG. 2 illustrates a flow chart of a method for enhancing downlink HARQ according to another embodiment of the invention;

FIG. 3 illustrates a block diagram of an apparatus for enhancing downlink HARQ according to an embodiment of the invention;

FIG. 4 illustrates a flow chart of a method for enhancing downlink HARQ according to an embodiment of the invention;

FIG. 5 illustrates a block diagram of an apparatus for enhancing downlink HARQ according to an embodiment of the invention;

FIG. 6 illustrates a LTE/LTE-A communication system for enhancing downlink HARQ according to an embodiment of the invention;

FIG. 7 illustrates SINR to capacity mapping according to an embodiment of the invention; and

FIG. 8 illustrates SINR to BLER mapping for different retransmission attempt according to an embodiment of the invention.

### DETAILED DESCRIPTION OF EMBODIMENTS

Various embodiments of the present invention are described in detail with reference to the drawings. The flowcharts and block diagrams in the figures illustrate the apparatus, method, as well as architecture, functions and operations executable by a computer program product according to the embodiments of the present invention. In this regard, each block in the flowcharts or block may represent a module, a program, or a part of code, which contains one or more executable instructions for performing specified logic functions. It should be noted that in some alternatives, functions indicated in blocks may occur in an order differing from the order as illustrated in the figures. For example, two blocks illustrated consecutively may be actually performed in parallel substantially or in an inverse order, which depends on related functions. It should also be noted that block diagrams and/or each block in the flowcharts and a combination of thereof may be implemented by a dedicated hardware-based system for performing specified functions/operations or by a combination of dedicated hardware and computer instructions.

Note that, in the invention, given that a packet has been retransmitted Q times, the term “next retransmission” refers to the (Q+1)^{th} retransmission; and the term “previous retransmissions” refers to part or all of the 1^{st} to Q^{th} retransmissions. In an embodiment of the present invention, the term “previous retransmissions” refers to all the 1^{st} to Q^{th} retransmissions.

This invention mainly focuses on CoMP, especially for the downlink multi-cell joint transmission.

The embodiments of the invention propose a novel scheme for enhancing downlink HARQ. The proposed HARQ enhancement method includes UE side and central unit side enhancements. CoMP UE first decodes the packet, and if it fails, it will estimate the required channel quality to recover the data information. Then with the knowledge of the channel quality of the eNBs in the cooperation set, it could decide which eNB or the combination of eNBs in the cooperation set could be used for the packet retransmission. Then it sends to the central unit an indication which suggests which eNBs would be used for the packet retransmission. Based on this indication, the central unit could free some eNBs in the cooperation set if there is no need to use them.

An embodiment of the present invention discloses a method for enhancing downlink HARQ. The method may comprise steps of: responsive to that a packet is unsuccessfully received, estimating a required channel quality for next retransmission of the packet; selecting a target subset of base stations from a cooperation set of base stations based on the required channel quality; and sending an indication of the target subset of base stations to a central unit. This method can be performed by a UE in a LTE/LET-A communication system.

An embodiment of the present invention discloses a method for enhancing downlink HARQ. The method may comprise steps of: receiving an indication of the target subset of base stations for next retransmission; and notifying the base stations in the target subset to retransmit the packet. This method can be performed by a central unit in a LTE/LET-A communication system.

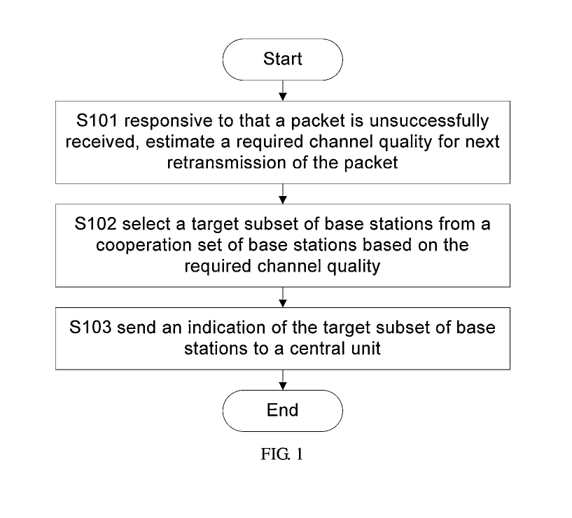

FIG. 1 illustrates a flow chart of a method for enhancing downlink HARQ according to an embodiment of the invention.

This embodiment may be implemented in the HARQ process at UE side as follows. Data from eNB may be demodulated first in the UE. Then the demodulated data with different RV of the same packet for channel decoding is combined by using chase combining (CC) or incremental redundancy (IR) methods. Then the combined data is decoded. The CRC value of the decoded packet is calculated and compared with the CRC information carried in the original packet to determine whether the packet is received successfully or not. If the packet is received successfully, an ACK will be sent; and if not, a NACK will be sent with an indication of a target subset of base stations with which the next retransmission will be performed. According to an embodiment of the present invention, the indication may be sent with NACK at the same time, or a little bit earlier or later. The indication may be obtained according to step S101-S103.

At step S101, responsive to that a packet is unsuccessfully received, a required channel quality for next retransmission of the packet is estimated.

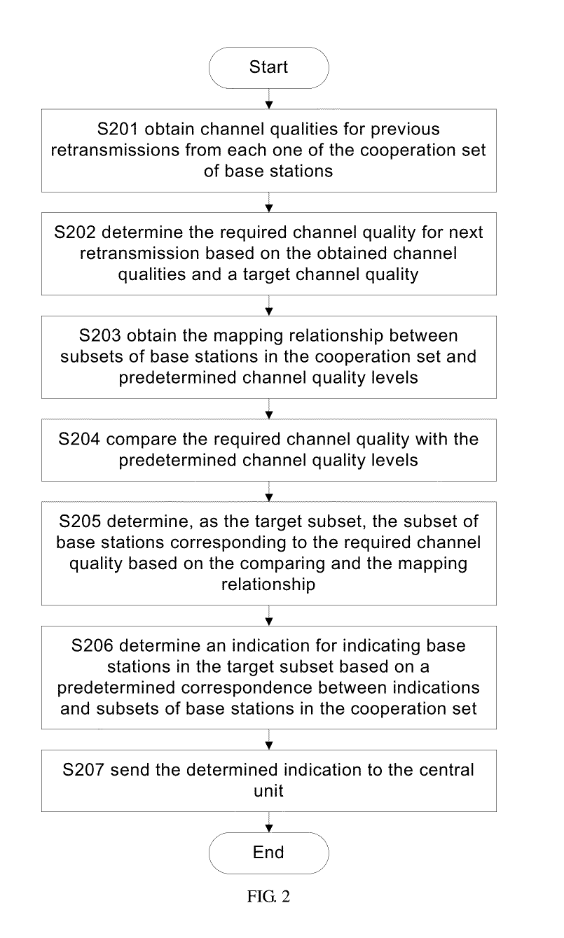

In an embodiment of the present application, channel qualities for previous retransmissions may be first obtained from each one of the cooperation set of base stations; and then the required channel quality for next retransmission may be determined based on the obtained channel qualities and a target channel quality. The embodiment will be described in detail in Steps 201-202 of FIG. 2.

At step S102, a target subset of base stations is selected from a cooperation set of base stations based on the required channel quality.

In an embodiment of the present application, the mapping relationship between subsets of base stations in the cooperation set and predetermined channel quality levels may be obtained, and the required channel quality may be compared with the predetermined channel quality levels; and the subset of base stations corresponding to the required channel quality may be determined as the target subset based on the comparison and the mapping relationship. The embodiment will be described in detail in Steps 203-205 of FIG. 2.

At step S103, an indication of the target subset of base stations is sent to a central unit.

In an embodiment of the present application, determining an indication for indicating base stations in the target subset based on a predetermined correspondence between indications and subsets of base stations in the cooperation set; and sending the determined indication to the central unit.

Then, the flow of the embodiment of FIG. 1 ends up.

As can be appreciated by a skilled in the art, many other suitable means known in the art may be adopted and the method illustrated herein is only shown as an example rather than limitation.

FIG. 2 illustrates a flow chart of a method for enhancing downlink HARQ according to another embodiment of the invention.

At step S201, channel qualities for previous retransmissions from each one of the cooperation set of base stations are obtained.

In the present invention, the channel quality may be selected from at least one of SINR (Signal to Interference plus Noise Ratio), SNR (Signal Noise Ratio), CINR (Carrier to Interference plus Noise Ratio), and CNR (Carrier to Noise Ratio). In this embodiment, SINR is taken as an example to represent the channel quality. Note that, in other embodiments of the present invention, the channel quality may be SNR, CINR, CNR or any combination of SINR, SNR, CINR, and CNR.

In an embodiment of the present invention, assuming that there are three base stations (e.g., eNB0, eNB1 and eNB2) in the cooperation set serving a UE and a packet has been retransmitted to the UE for two times. The channel qualities for previous retransmissions from each one of the cooperation set of base stations may be represented as SINR_{n,i}, wherein n denotes the subcarrier for transmitting the packet from the n^{th} eNB to the UE, and i denotes the i^{th} retransmission. The channel qualities may be obtained from a memory in which SINR_{n,i} acquired from the i^{th} retransmission on the n^{th} subcarrier is stored, wherein n=0, 1 and 2, and i=1 and 2.

As can be appreciated by a skilled in the art, the memory may be a portable computer magnetic disk, hard disk, random access memory (RAM), read-only memory (ROM), erasable programmable read-only memory (EPROM or flash), optical fiber, portable compact disk read-only memory (CD-ROM), optical storage device, or a magnetic storage device.

As can be appreciated by a skilled in the art, although the channel quality SINR_{n,i} is exemplarily obtained from the memory, it can be obtained by any other suitable means known in the art.

At step S202, the required channel quality for next retransmission is determined based on the obtained channel qualities and a target channel quality.

In embodiments of the present application, a packet has been retransmitted Q times, the term “next retransmission” refers to the (Q+1)^{th} retransmission; and the term “previous retransmissions” refers to the 1^{st} to Q^{th} retransmissions.

In embodiments of the present application, data received from base station (for example, eNB) can be demodulated and then combined by using chase combining (CC) method, incremental redundancy (IR) method, and so on, so as to be further decoded.

In an embodiment of the present application, the data is combined by using CC method. The SINR of retransmitted packets are summed together across retransmissions. To correctly decode the packet, the channel quality to be obtained after the (Q+1)^{th} retransmission should exceed the target channel quality for the (Q+1)^{th} retransmission. Given a sub-carrier n, the required channel quality for the (Q+1)^{th} retransmission on sub-carrier n, which is denoted as SINR_{n,Q+1}, may be obtained based on equations set (1) as below.

$$\{ \begin{matrix}\frac{1}{2} {\sum }_{n = 1}^{N} {I}_{m} ( \overline{{SINR}_{n}} ) \geq {I}_{m} ( {SINR}_{target , Q + 1} ) \\ {I}_{m} ( \overline{{SINR}_{n}} ) = {I}_{m} ( {\sum }_{i = 1}^{Q + 1} {SINR}_{n , i} )\end{matrix} \qquad ( 1 )$$

### Where

Iₘ( ) is the mutual information function;
N is the number of sub-carriers; and
SINR_{target,Q+1} is the target channel quality for the (Q+1)^{th} retransmission.

The target channel quality represents a threshold channel quality for the next retransmission. If a mutual information obtained based on the candidate channel quality SINR_{n,Q+1} for the next retransmission and channel qualities SINR_{n,i} (i=1, . . . , Q) for the previous retransmissions is lager than the mutual information obtained based on the target channel quality, then the channel quality SINRn,Q+1 can be used for the next retransmission to ensure the packet can be successfully received in the next retransmission.

The target channel quality can be preset according to priori knowledge, or obtained through offline link level simulation or obtained by any other suitable means known in the art.

In another embodiment of the present application, the data is combined by using IR method. In this case, given a sub-carrier n, the required channel quality for the (Q+1)^{th} retransmission on sub-carrier n, which is denoted as SINR_{n,Q+1}, may be obtained based on equations set (2) as below.

$$\{ \begin{matrix}\frac{1}{N} {\sum }_{n = 1}^{N} {I}_{m} ( \overline{{SINR}_{n}} ) \geq {I}_{m} ( {SINR}_{target , Q + 1} ) \\ {I}_{m} ( \overline{{SINR}_{n}} ) = \frac{\begin{matrix}{N}_{pre} {I}_{m} ( {SINR}_{n , Q} ) + {N}_{NR} {I}_{m} ( {SINR}_{n , Q + 1} ) + \\ {N}_{R} {I}_{m} ( {I}_{m}^{- 1} ( {I}_{m} ( {SINR}_{n , Q} ) ) + {I}_{m}^{- 1} ( {I}_{m} ( {SINR}_{n , Q + 1} ) ) )\end{matrix}}{{N}_{pre} + {N}_{NR} + {N}_{R}}\end{matrix} \qquad ( 2 )$$

### Where

Nₚᵣₑ is the number of code bits that are not retransmitted in this retransmission;
N_{R} is the number of code bits that are retransmitted in this retransmission; and
N_{NR} is the number of new code bits that are transmitted in this transmission.

The above equations set (2) illustrate that post SINR should exceed the SINR target for the (Q+1)^{th} retransmission. For incremental redundancy combining, the mutual information of combined SINR on each sub-carrier should be the mutual information of previously transmitted bits before the (Q+1)^{th} retransmission, plus retransmitted bits in the (Q+1)^{th} retransmission and new transmitted bits in the (Q+1)^{th} retransmission. So the required SINR for the (Q+1)^{th} retransmission could be estimated, and UE could select the appropriate eNBs which meet such SINR requirement.

In another embodiment of the present application, assuming that after the Q^{th} retransmission, the mutual information is Iₘ(SINR_{n,Q}). For simplicity, assuming that the next retransmission packet has the same packet length as the previous ones. In this case, equations set (2) could be written as the following inequation (3).

$$\frac{1}{N} {\sum }_{n = 1}^{N} \frac{{QI}_{m} ( {SINR}_{n , Q} ) + {I}_{m} ( {SINR}_{n , Q + 1} )}{Q + 1} \geq {I}_{m} ( {SINR}_{target , Q + 1} ) \qquad ( 3 )$$

In another embodiment of the present application, assuming that the SINR requirement for the (Q+1)^{th} retransmission is the same across the sub-carriers. In this case, equations set (2) could be written as the following equations set (4).

$$\{ \begin{matrix}{I}_{m} ( {SINR}_{Q + 1} ) \geq ( Q + 1 ) {I}_{m} ( {SINR}_{target , Q + 1} ) - {QI}_{m} ( {SINR}_{Q} ) \\ {I}_{m} ( {SINR}_{Q} ) = \frac{1}{N} {\sum }_{n = 1}^{N} {I}_{m} ( {SINR}_{n , Q} )\end{matrix} \qquad ( 4 )$$

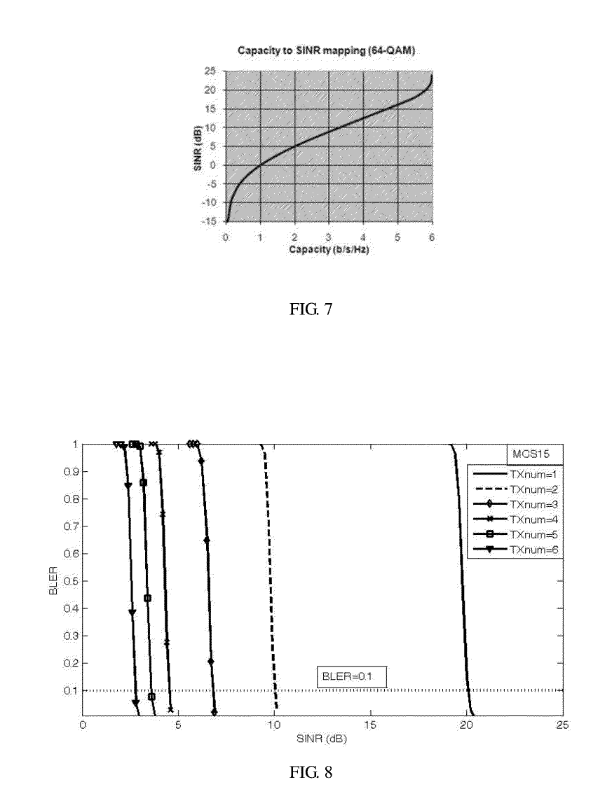

Here the mutual information is represented by capacity, and an SINR to capacity mapping function is given in FIG. 7. FIG. 8 gives the SINR to BLER mapping for different retransmission attempt when Modulation and coding scheme MCS=15. So the SINR_{target,Q+1} for the (Q+1)^{th} retransmission could be easily calculated assuming that BLER (block error rate) equals 0.1.

At step S203, the mapping relationship between subsets of base stations in the cooperation set and predetermined channel quality levels is obtained.

In an embodiment of the present invention, the mapping relationship between subsets of base stations and predetermined channel quality levels may be preset according to priori knowledge, or predefined according to reference of those skilled in the art, or predetermined by operator's specification.

In an embodiment of the present invention, the mapping relationship between subsets of base stations and predetermined channel quality levels may be stored in a memory in advance. The memory may be a portable computer magnetic disk, hard disk, random access memory (RAM), read-only memory (ROM), erasable programmable read-only memory (EPROM or flash), optical fiber, portable compact disk read-only memory (CD-ROM), optical storage device, a magnetic storage device, or any other suitable storage.

In an embodiment of the present invention, assuming that the cooperation set of base stations serving a UE comprise three eNBs, that is, eNB0, eNB1 and eNB2, where eNB0 is a serving eNB and eNB1 and eNB2 are coordinated eNBs. An example of the mapping relationship between subsets of base stations in the cooperation set and SINR levels is illustrated as Table 1.

TABLE 1

| Subsets | SINR (dB) |
|---|---|
| eNB0 | 0.46 |
| eNB0 + eNB1 | 2.28 |
| eNB0 + eNB2 | 5.46 |
| eNB0 + eNB1 + eNB2 | 8.56 |

As can be seen from Table 1, if a required channel quality is in a range between 0.46 dB and 2.28 dB (including 2.28 dB), or if a required channel quality is below 0.46 dB, only eNB0 is enough for the next retransmission, hence the target subset only comprises one base station, eNB0; if a required channel quality is in a range between 2.28 dB and 5.46 dB (including 5.46 dB), eNB0 and eNB1 need to cooperate in the next retransmission, hence the target subset comprises two base stations, eNB0 and eNB1; if a required channel quality is in a range between 5.46 dB and 8.56 dB (including 8.56 dB), eNB0 and eNB2 need to cooperate in the next retransmission, hence the target subset comprises two base stations, eNB0 and eNB2; and if a required channel quality is lager than 8.56 dB, all of eNB0, eNB1 and eNB2 need to cooperate in the next retransmission, hence the target subset comprises three base stations, eNB0, eNB1 and eNB2.

At step S204, the required channel quality is compared with the predetermined channel quality levels.

When the (Q+1)^{th} retransmission required channel quality SINR_{n,Q+1} is obtained in step S204, it can be compared with the predetermined channel quality levels. In an embodiment of the present invention, assuming the required channel quality SINR_{n,Q+1} is 2.8 dB, it can be determined the SINR_{n,Q+1} falls into the range between 2.28 dB and 5.46 dB.

At step S205, the subset of base stations corresponding to the required channel quality is determined as the target subset based on the comparing and the mapping relationship.

As indicated above, if the SINR_{n,Q+1} falls into the range between 2.28 dB and 5.46 dB, it can be determined, based on Table 1, that the target subset of base stations corresponding to the required channel quality SINR_{n,Q+1} comprises eNB0 and eNB1.

At step S206, an indication for indicating base stations in the target subset is determined based on a predetermined correspondence between indications and subsets of base stations in the cooperation set.

There are several ways to determine the indication.

In an embodiment of the present invention, an example of a predetermined correspondence between indications and subsets of base stations in the cooperation set is given in Table 2.

TABLE 2
Correspondence Example 1

| | | Indication |
|---|---|---|
| Subsets | SINR (dB) | (CQI) |
| eNB0 | 0.46 | 5 |
| eNB0 + eNB1 | 2.28 | 6 |
| eNB0 + eNB2 | 5.46 | 7 |
| eNB0 + eNB1 + eNB2 | 8.56 | 9 |

For downlink CoMP operation, the CoMP UE's channel state information (CSI) is needed for the central unit to carry out CoMP scheduling process. The CSI generally includes precoding matrix indicator (PMI), rank indication (RI) and channel quality indicator (CQI). The UE will report the individual per-cell feedback, together with complementary feedbacks with subsets of eNBs in the cooperation set. Table 2 shows a typical SINR measurement result, from which the SINR-CQI mapping can be obtained. Then, according to the SINR-CQI mapping, the CQI could be obtained as the CSI information which is subsequently reported with periodic feedback on PUCCH or a periodic feedback on PUSCH.

For example, assuming the required channel quality SINR_{n,Q+1} obtained in step S204 is 2.8 dB, it can be determined that the SINR_{n,Q+1} falls into the range between 2.28 dB and 5.46 dB (step S204) and the target subset of base stations corresponding to the required channel quality SINR_{n,Q+1} comprises eNB0 and eNB1 (step S205). At step S206, based on Table 2, it can be determined that the target subset comprising eNB0 and eNB1 corresponds to a CQI with value of “7”. In this case, CQI “7” can be taken as an indication which indicating the target subset comprising eNB0 and eNB1.

In another embodiment of the present invention, an example of a predetermined correspondence between indications and subsets of base stations in the cooperation set is given in Table 3.

TABLE 3
Correspondence Example 2

| Indication (2 bits message) | Subsets |
|---|---|
| 00 | eNB0 |
| 01 | eNB0 + eNB1 |
| 10 | eNB0 + eNB2 |
| 11 | eNB0 + eNB1 + eNB2 |

For example, when the target subset of base stations corresponding to the required channel quality SINR_{n,Q+1} comprises eNB0 and eNB1, it can be determined, based on Table 3, that the target subset comprising eNB0 and eNB1 corresponds to a 2 bits message with value of “01”. In this case, the message “01” can be taken as an indication which indicating the target subset comprising eNB0 and eNB1.

As can be appreciated by a skilled in the art, although the above embodiments of the present invention provide only two examples of indication, many other suitable forms of indication known in the art may be applicable.

At step S207, the determined indication is sent to the central unit.

According to the present invention, a NACK will be sent in response to a packet is received unsuccessfully. In an embodiment of the present invention, the determined indication may be sent with NACK at the same time, or earlier or later than NACK.

Then, the flow of the embodiment of FIG. 2 ends up.

As can be appreciated by a skilled in the art, many other suitable means known in the art may be adopted and the method illustrated herein is only shown as an example rather than limitation.

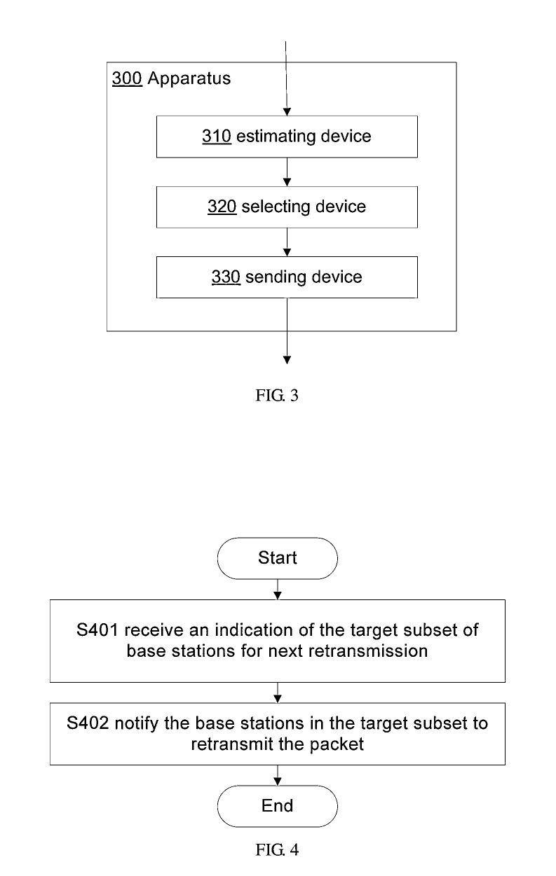

FIG. 3 illustrates a block diagram of an apparatus 300 for enhancing downlink HARQ according to an embodiment of the invention.

In an embodiment of the present invention, the apparatus 300 may comprises: an estimating device 310, a selecting device 320 and a sending device 330. The estimating device 310 may be configured to responsive to that a packet is unsuccessfully received, estimate a required channel quality for next retransmission of the packet. The selecting device 320 may be configured to select a target subset of base stations from a cooperation set of base stations based on the required channel quality. The sending device 330 may be configured to send an indication of the target subset of base stations to a central unit.

In an embodiment of the present invention, the estimating device 310 may comprise: means configured to obtain channel qualities for previous retransmissions from each one of the cooperation set of base stations; and means configured to determine the required channel quality for next retransmission based on the obtained channel qualities and a target channel quality.

In an embodiment of the present invention, the selecting device 320 may comprise: means configured to obtain the mapping relationship between subsets of base stations in the cooperation set and predetermined channel quality levels; means configured to compare the required channel quality with the predetermined channel quality levels; and means configured to determine, as the target subset, the subset of base stations corresponding to the required channel quality based on the comparing and the mapping relationship.

In an embodiment of the present invention, the sending device 330 comprise: means configured to determine an indication for indicating base stations in the target subset based on a predetermined correspondence between indicators and subsets of base stations in the cooperation set; and means configured to send the determined indication to the central unit.

In an embodiment of the present invention, the channel quality may be selected from at least one of SINR, SNR, CINR, and CNR.

FIG. 4 illustrates a flow chart of a method for enhancing downlink HARQ according to an embodiment of the invention.

At step S401, an indication of the target subset of base stations for next retransmission is received.

In an embodiment of the present invention, when the indication of the target subset of base stations for next retransmission is received, the target subset of base stations can be determined based on a predetermined correspondence between indicators and subsets of base stations in the cooperation set.

There are several ways to determine the base stations in the target subset according to the received indication. As mentioned above, examples of a predetermined correspondence between indications and subsets of base stations in the cooperation set are given in Table 2 and Table 3. Based on the correspondence predefined in Table 2 or Table 3, the target subset corresponds to the received indication can be easily obtained, accordingly the member base stations in the target subset can be determined.

At step S402, the base stations in the target subset are notified to retransmit the packet.

In this step, only the base stations in the target subset will receive notification to perform retransmission. As the base stations in the target subset is only part of all base stations in the cooperation set, radio resource of those base stations which do not receive the notification will be saved.

Then, the flow of the embodiment of FIG. 4 ends up.

As can be appreciated by a skilled in the art, many other suitable means known in the art may be adopted and the method illustrated herein is only shown as an example rather than limitation.

FIG. 5 illustrates a block diagram of an apparatus 500 for enhancing downlink HARQ according to an embodiment of the invention.

In an embodiment of the present invention, the apparatus 500 may comprise: a receiving device 510 and a notifying device 520. The receiving device may be configured to receive an indication of the target subset of base stations for next retransmission. The notifying device may be configured to notify the base stations in the target subset to retransmit the packet.

In an embodiment of the present invention, the receiving device 510 may comprise: means configured to determine the target subset of base stations based on a predetermined correspondence between indicators and subsets of base stations in a cooperation set.

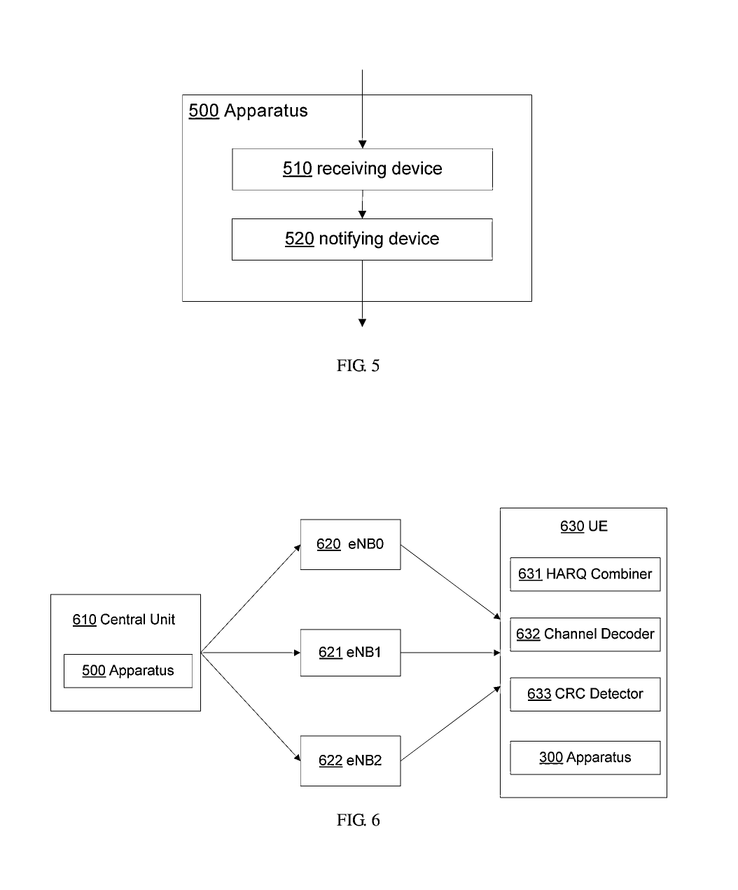

FIG. 6 illustrates a LTE/LTE-A communication system for enhancing downlink HARQ according to an embodiment of the invention.

The system comprises a central unit 610, three base stations (eNB0 620, eNB1 621, and eNB2 622) and a UE 630. The UE 630 may comprise a HARQ combiner 631, a channel decoder 632, a CRC detector 633 and an apparatus 300 for enhancing downlink HARQ according to the present invention as illustrated in FIG. 3. The central unit 610 may comprise an apparatus 500 for enhancing downlink HARQ according to the present invention as illustrated in FIG. 5.

In the system, data transmitted from eNB0 620, eNB1 621, and eNB2 622 may be demodulated first at the UE 630. Then the demodulated data with different RV of the same packet for channel decoding may be combined by using chase combining (CC) or incremental redundancy (IR) methods at HARQ combiner 631. The combined data is decoded at channel decoder 632. Then, at CRC detector 633, the CRC value of the decoded packet is calculated and compared with the CRC information carried in the original packet to determine whether the packet is received successfully or not. If the packet is received successfully, an ACK will be sent; and if not, a NACK will be sent with an indication of a target subset of base stations. The indication may be obtained by the apparatus 300 for enhancing downlink HARQ. Specifically, a required channel quality for next retransmission of the packet may be estimated first in response to that a packet is unsuccessfully received, then a target subset of base stations may be selected from a cooperation set of base stations based on the required channel quality, and finally an indication of the target subset of base stations may be sent to a central unit.

The central unit 610 comprises an apparatus 500 for enhancing downlink HARQ. During the HARQ process, the apparatus 500 receives an indication of the target subset of base stations for next retransmission, and notifies the base stations in the target subset to retransmit the packet.

The proposed HARQ enhancement method and apparatus could help central unit to release some unnecessary eNBs in HARQ retransmission, so that these eNBs could transmit new information. Therefore, part of the radio resource is saved.

Embodiments of the present invention may also be implemented as a computer program product, comprising at least one computer readable storage medium having a computer readable program code portion stored thereon. In such embodiments, the computer readable program code portion comprises at least codes for enhancing downlink HARQ. In an embodiment of the present invention, a computer program may comprise: codes for responsive to that a packet is unsuccessfully received, estimating a required channel quality for next retransmission of the packet; codes for selecting a target subset of base stations from a cooperation set of base stations based on the required channel quality; and codes for sending an indication of the target subset of base stations to a central unit. In another embodiment of the present invention, a computer program may comprise: codes for receiving an indication of the target subset of base stations for next retransmission; and codes for notifying the base stations in the target subset to retransmit the packet.

Based on the above description, the skilled in the art would appreciate that the present invention may be embodied in an apparatus, a method, or a computer program product. Thus, the present invention may be specifically implemented in the following manners, i.e., complete hardware, complete software (including firmware, resident software, microcode, etc), or a combination of software part and hardware part as generally called “circuit,” “module,” or “system” herein. Further, the present invention may also adopt a form of computer program product as embodied in any tangible medium of expression, the medium comprising computer-usable program code.

Any combination of one or more computer-usable or computer-readable mediums may be used. The computer-usable or computer-readable medium may be for example, but not limited to, electrical, magnetic, optical, electromagnetic, infrared, or semiconductor system, means, device, or propagation medium. More specific examples (non-exhaustive list) of the computer-readable medium comprise: an electric connection having one or more leads, a portable computer magnetic disk, hard disk, random access memory (RAM), read-only memory (ROM), erasable programmable read-only memory (EPROM or flash), optical fiber, portable compact disk read-only memory (CD-ROM), optical storage device, a transmission medium for example, supporting internet or intranet, or a magnetic storage device. It should be noted that the computer-usable or computer readable medium may even be a paper printed with a program thereon or other suitable medium, because the program may be obtained electronically by electrically scanning such paper or other medium, and then compiled, interpreted or processed in a suitable manner, and if necessary, stored in a computer memory. In the context of the present document, a computer-usable or computer-readable medium may be any medium containing, storing, communicating, propagating, or transmitting a program available for an instruction execution system, apparatus or device, or associated with the instruction execution system, apparatus, or device. A computer-usable medium may comprise a data signal contained in a base band or propagated as a part of carrier and embodying a computer-usable program code. A computer-usable program code may be transmitted by any suitable medium, including, but not limited to, radio, wire, cable, or RF, etc.

A computer program code for executing operations of the present invention may be written by any combination of one or more program design languages, the program design languages including object-oriented program design languages, such as Java, Smalltalk, C++, etc, as well as conventional procedural program design languages, such as “C” program design language or similar program design language. A program code may be completely or partly executed on a user computer, or executed as an independent software package, partly executed on the user computer and partly executed on a remote computer, or completely executed on a remote computer or server. In the latter circumstance, the remote computer may be connected to the user computer through various kinds of networks, including local area network (LAN) or wide area network (WAN), or connected to external computer (for example, by means of an internet service provider via Internet).

Further, each block in the flow charts and/or block diagrams of the present invention and combination of respective blocks therein may be implemented by computer program instructions. These computer program instructions may be provided to a processor of a general purpose computer, a dedicated computer or other programmable data processing apparatus, thereby generating a machine such that these instructions executed through the computer or other programmable data processing apparatus generate means for implementing functions/operations prescribed in the blocks of the flow charts and/or block diagrams.

These computer program instructions may also be stored in a computer-readable medium capable of instructing the computer or other programmable data processing apparatus to work in a particular manner, such that the instructions stored in the computer-readable medium generate a product including instruction means for implementing the functions/operations prescribed in the flow charts and/or block diagrams.

The computer program instructions may also be loaded on a computer or other programmable data processing apparatus, such that a series of operation steps are implemented on the computer or other programmable data processing apparatus, to generate a computer-implemented process, such that execution of the instructions on the computer or other programmable apparatus provides a process of implementing the functions/operations prescribed in the blocks of the flow charts and/or block diagrams.

Though the exemplary embodiments of the present invention are described herein with reference to the drawings, it should be understood that the present invention is not limited to these accurate embodiments, and a person of normal skill in the art can make various modifications to the embodiments without departing from the scope and principle of the present invention. All such variations and modifications are intended to be included in the scope of the present invention as defined in the appended claims.

What is claimed is:

1. A method for enhancing downlink HARQ, comprising:
responsive to that a packet is unsuccessfully received, estimating a required channel quality for next retransmission of the packet;
selecting a target subset of base stations from a cooperation set of base stations based on the required channel quality; and
sending an indication of the target subset of base stations to a central unit.

2. The method of claim 1, wherein responsive to that a packet is unsuccessfully received, estimating a required channel quality for next retransmission of the packet comprises:
obtaining channel qualities for previous retransmissions from each one of the cooperation set of base stations; and
determining the required channel quality for next retransmission based on the obtained channel qualities and a target channel quality.

3. The method of claim 1, wherein selecting a target subset of base stations from a cooperation set of base stations based on the required channel quality comprises:
obtaining the mapping relationship between subsets of base stations in the cooperation set and predetermined channel quality levels;
comparing the required channel quality with the predetermined channel quality levels; and
determining, as the target subset, the subset of base stations corresponding to the required channel quality based on the comparing and the mapping relationship.

4. The method of claim 1, wherein sending an indication of the target subset of base stations to a central unit comprises:
determining an indication for indicating base stations in the target subset based on a predetermined correspondence between indications and subsets of base stations in the cooperation set; and
sending the determined indication to the central unit.

5. The method of claim 1, wherein the channel quality is selected from at least one of SINR, SNR, CINR, and CNR.

6. A method for enhancing downlink HARQ, comprising:
receiving an indication of the target subset of base stations for next retransmission; and
notifying the base stations in the target subset to retransmit the packet.

7. The method of claim 6, wherein receiving an indication of the target subset of base stations for next retransmission comprises:
determining the target subset of base stations based on a predetermined correspondence between indicators and subsets of base stations in a cooperation set.

8. An apparatus for enhancing downlink HARQ, comprising:
an estimating device, configured to responsive to that a packet is unsuccessfully received, estimate a required channel quality for next retransmission of the packet;
a selecting device, configured to select a target subset of base stations from a cooperation set of base stations based on the required channel quality; and
a sending device, configured to send an indication of the target subset of base stations to a central unit.

9. The apparatus of claim 8, wherein the estimating device comprises:
means configured to obtain channel qualities for previous retransmissions from each one of the cooperation set of base stations; and
means configured to determine the required channel quality for next retransmission based on the obtained channel qualities and a target channel quality.

10. The apparatus of claim 8, wherein the selecting device comprises:
means configured to obtain the mapping relationship between subsets of base stations in the cooperation set and predetermined channel quality levels;
means configured to compare the required channel quality with the predetermined channel quality levels; and
means configured to determine, as the target subset, the subset of base stations corresponding to the required channel quality based on the comparing and the mapping relationship.

11. The apparatus of claim 8, wherein the sending device comprises:
means configured to determine an indication for indicating base stations in the target subset based on a predetermined correspondence between indicators and subsets of base stations in the cooperation set; and
means configured to send the determined indication to the central unit.

12. The apparatus of claim 8, wherein the channel quality is selected from at least one of SINR, SNR, CINR, and CNR.

13. An apparatus for enhancing downlink HARQ, comprising:
a receiving device, configured to receive an indication of the target subset of base stations for next retransmission; and
a notifying device, configured to notify the base stations in the target subset to retransmit the packet.

14. The apparatus of claim 13, wherein the receiving device comprises:
means configured to determine the target subset of base stations based on a predetermined correspondence between indicators and subsets of base stations in a cooperation set.
